(19) United States
(12) Patent Application Publication
(10) Pub. No.: US 2004/0208587 A1
(43) Pub. Date: Oct. 21, 2004

(54) Method of optical network routing

(76) Inventors: Frank Y. Chang, Ottawa (CA); Mazda M. Salmanian, Kanata (CA)

Correspondence Address: GOWLING LAFLEUR HENDERSON, Suite 2600, 160 Elgin Street, Ottawa, ON, K1P 1C3, CA

(21) Appl. No.: 10/002,857

(22) Filed: Dec. 5, 2001

(51) Int. Cl. H04J 14/02; H04B 10/00

(52) U.S. Cl. 398/100

(57) ABSTRACT

For an optical network including photonic nodes and photonic/optical node, we introduce a concept of photonic cell. Each optical node with DWDM optics forms a base node for a photonic cell. Nodes are members of a photonic cell if they are within optical reach of the base node. Every other optical node with DWDM optics within the photonic cell also serves as a base node for its own photonic cell. By mapping the network to overlapping photonic cells, route alternatives can be determined by using the cell membership tables as a constraint rather than having to invoke complex link engineering computations as part of the routing method.

### FIELD OF THE INVENTION

The present invention relates to optical networks and is particularly concerned with methods of routing.

### BACKGROUND OF THE INVENTION

Conventional optical backbone networks consist of line systems (amplifiers and regenerators), add-drop multiplexers (ADMs) and digital cross-connects.

A new generation of optical networks will have the network intelligence to support a wide range of advanced features and new services. Routing is certainly an important ingredient of network intelligence. These networks will also consist of both electrical switches (aka SONET switches) as well as photonic switches. Lightpaths can then traverse multiple hops all-optically without going through signal regeneration.

There are many benefits associated with the deployment of photonic switches. However, the benefits offered by photonic switching impose some very challenging requirements on routing. Routing at conventional optical networks may need to consider only hop count, bandwidth availability and matching on encoding type/line rate. In photonic networks, one needs to look at non-linear effects, optical reach limitation, fiber types, etc.

Next generation optical networks will have both photonic and electrical switches that are deployed throughout the network. Referring to FIG. 1, there is illustrated two forms of next generation optical switch. A typical node 10 will include both a photonic cross-connect switch 12 and an electrical cross connect switch 14, with 0-1 conversion/regeneration 16. In some cases the switch may be all photonic with DWDM optics for local traffic add drop as depicted by 18. While the switch has one general configuration it is the node size that makes the nodes different. Some nodes would require more ports on the electrical switches, some nodes would require more ports on the photonic switches, and some nodes would not require any ports on the electrical switches. This port/capacity requirement can be determined through careful network capacity planning.

Instead of classifying nodes into different types, the attention should be focused on optical paths and how they traverse the network. FIG. 2 illustrates two different optical paths A and B whenever an optical path is passing through a node, there is a choice to pass through the node photonically via the photonic switch 12 or to pass through the electrical switch 14 for signal regeneration (and traffic groomming if needed). An optical path with a fewer number of electrical switch passthroughs (i.e. OEO or signal regeneration) tend to cost less as fewer number of ports are used. It is usually the objective of the network operator to minimize the cost of the optical paths by minimizing the number of OEO sites for every optical path. Consequently, optical path B in FIG. 2 costs less then optical path A.

Routing is defined here as a function to determine the route for an optical path to traverse the network. The routing function is relatively simple when it is limited to a single layer network. For example, when routing is done in the IP layer and the IP layer alone, routers and router ports are the entities the routing function should care about. The optical layer is just a set of point-to-point links between the router ports and it bears no routing significance to the IP routing function. Similarly, when routing is done in the SONET layer (i.e. optical networks with electrical (SONET) switches, SONET switches and SONET ports are the entities the routing function should care about. The photonic layer is just a set of point-to-point links between the SONET ports. It is assumed that proper link engineering is done and the optical signal sent from one SONET port will reach another SONET port. Optical reach is always assumed and it bears no significance to the SONET routing function.

The next generation optical network consists of two layers; namely the SONET layer and the photonic layer. Challenges arise when one wants to do integrated routing at both the SONET and photonic layers. All of a sudden, the routing function needs to consider factors that are important to both the SONET layers and the photonic layers. To determine a route for an optical path, the routing function can no longer determine the sequence of SONET switches without considering the photonic layer simultaneously.

What makes this integrated routing approach in the next generation optical networks uniquely challenging is the fact that the routing function is no longer dealing with a logical world. Routing in the photonic layer requires careful link engineering that takes into consideration of non-linear effects, optical reach limitation, fiber types, frequency continuity, and so on. This long and often labour-intensive process will slow down the routing process. One potential solution is to abstract the link engineering process into a logical (or mathematical) model to speed up the routing process. However, a link engineering model can be very complex and a practical abstraction is not generally available in the industry.

### SUMMARY OF THE INVENTION

Accordingly, the present invention provides a concept of photonic cells. Further aspects of the present invention apply photonic cells to network routing.

### BRIEF DESCRIPTION OF THE DRAWINGS

The present invention will be further understood from the following detailed description with reference to the drawings in which:

FIG. 1 illustrates two forms of next generation optical switch;

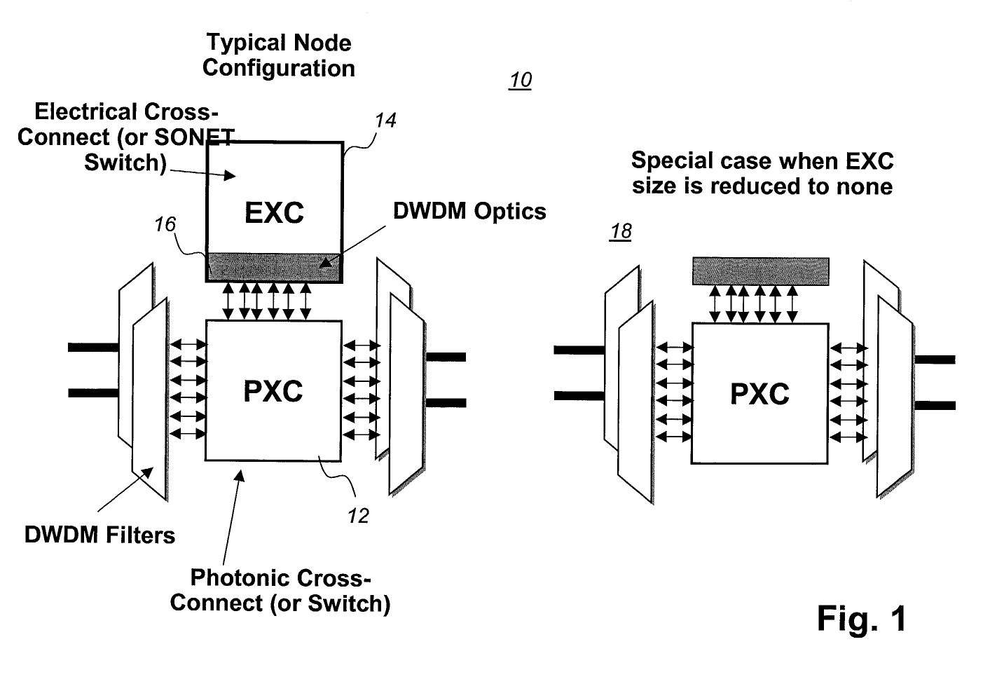

FIG. 2 illustrates two different optical paths through a next generation optical network;

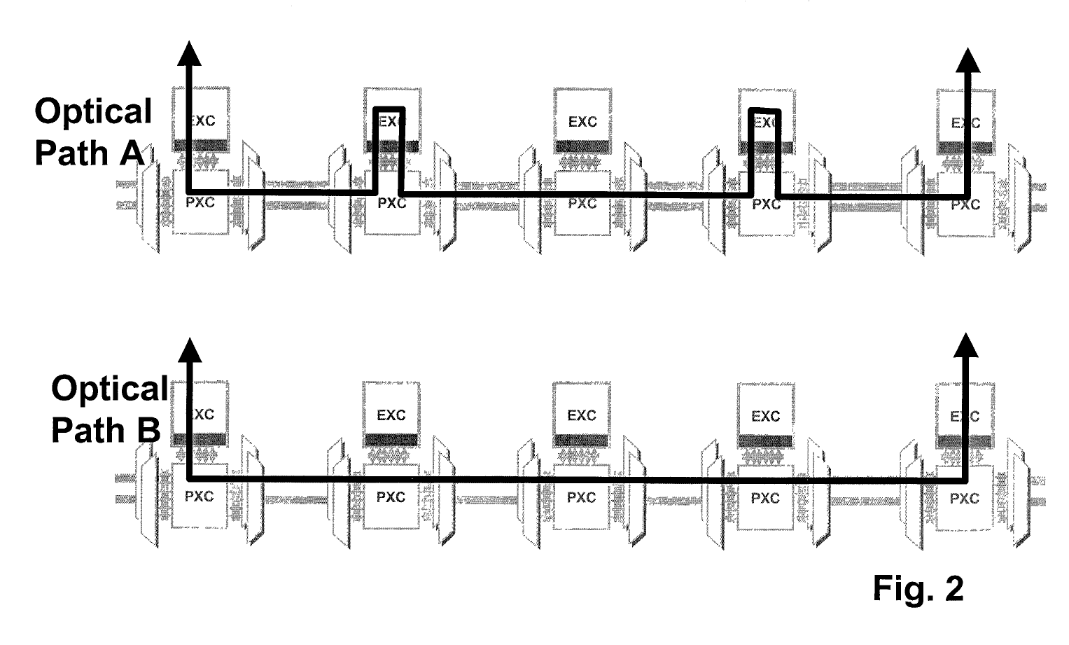

FIG. 3 illustrates in a block diagram separating network engineering from network routing using a photonic cell in accordance with an embodiment of the present invention;

FIG. 4 illustrates a simplified view of a photonic cell in accordance with an embodiment of the present invention;

FIGS. 5a and 5b graphically illustrate Corollary 1 and Corollary 2 in accordance with an embodiment of the present invention;

FIGS. 6a and 6b illustrate application of the photonic cell concept of FIGS. 3 and 4 to simplified network routing example;

FIGS. 7a, 7b and 7c illustrate application of the photonic cell concept to a more complex routing example; and

FIG. 8 graphically illustrates another application of photonic cells to network routing.

### DETAILED DESCRIPTION OF THE PREFERRED EMBODIMENT

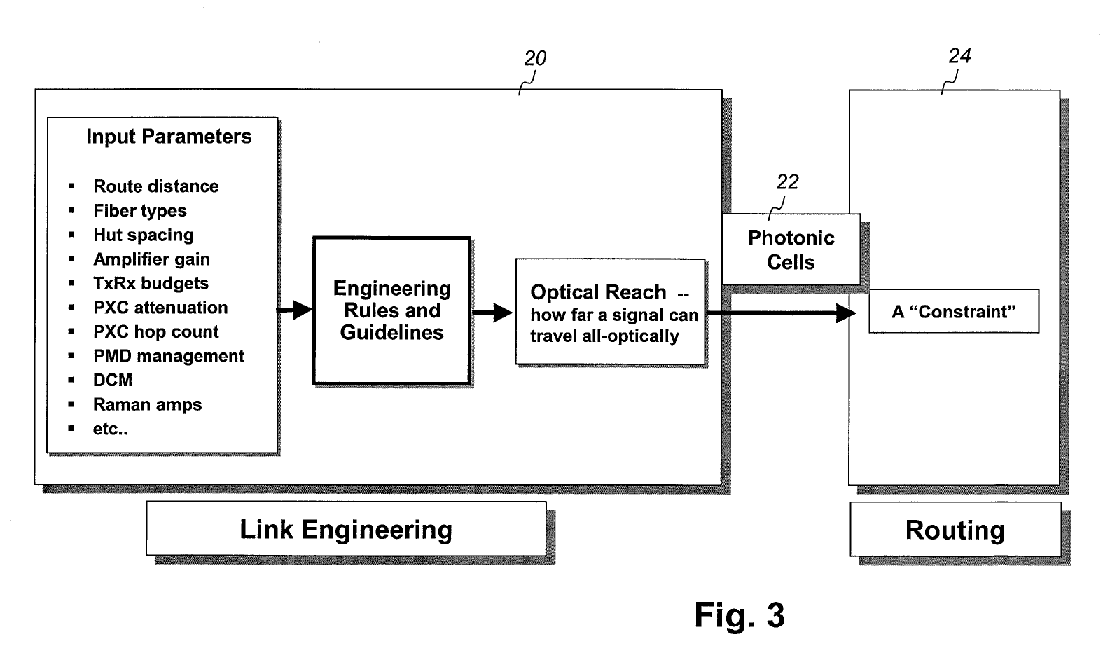

Our solution to the problem discussed herein above is to decouple the slow and complex link engineering process from the logical routing process as depicted in FIG. 3. Link engineering 20 can be done with a totally independent time schedule. The results of the link engineering process 20 are then represented by the photonic cells 22 and incorporated into the routing process 24.

The link engineering block 20 shown in FIG. 3 represents the optical reach computation. The output of this process is to determine, for any given node, what other nodes can be reached photonically without signal regenerations. The set of these nodes form a photonic cell.

These photonic cells provide additional parameters (or constraints) to the routing process 24. The routing function 24 can now rely on the information abstracted by the photonic cells 22 to handle the photonic layer without any involvement in the actual link engineering 20. Note that the present embodiments of the invention do not prescribe how the photonic cells can be incorporated into various routing implementations.

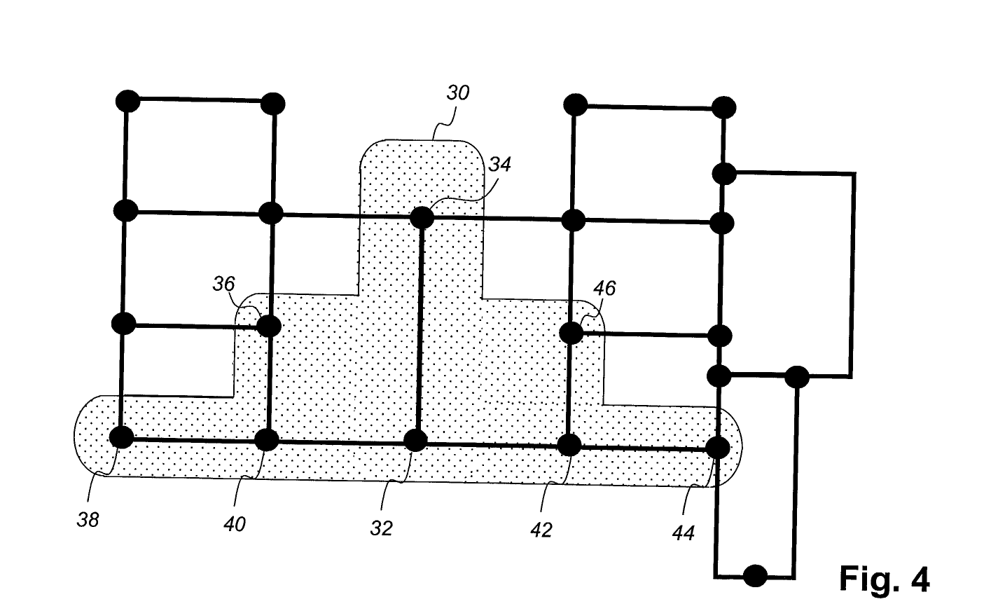

FIG. 4 provides a very simple illustration of the definition of a photonic cell. A photonic cell (PC) 30 denotes an area within which any optical signals originated from a base node 32 can reach photonically (all-optically) without any signal regeneration. In other words, the boundary of the photonic cell 30 is its optical reach.

Photonic cells have the following properties:

Every node (32, 34, 36, 38, 40, 42, 44, 46) is the base node for its own photonic cell.

Photonic cells from different nodes can be overlapped.

We have defined a photonic cell as the area where any optical paths originate from the base node can reach any other nodes (cell members) within that area photonically (without signal regeneration). This is Corollary 1.

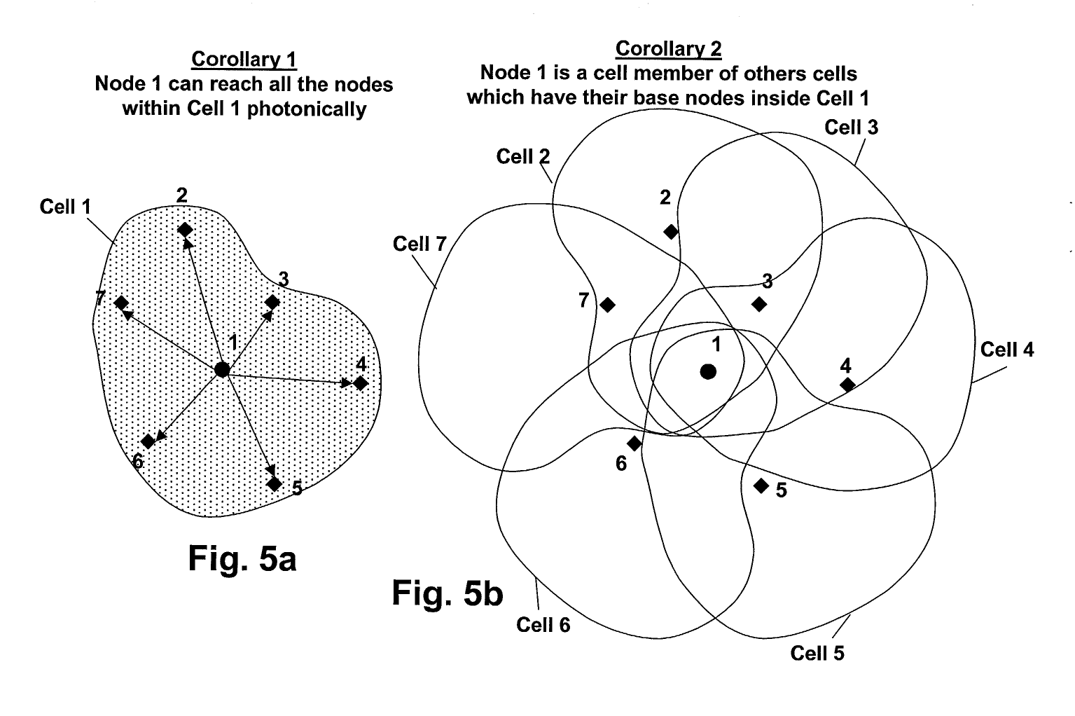

Corollary 1 is graphically illustrated in FIG. 5a.

In Corollary 2, a photonic cell 1 of a base node 1 defines an area with a set of cell members (2,3,4, . . . 7). These cell members by definition have their own respective photonic cells (2,3,4, . . . 7). Therefore, it is equally valid to say that base node 1 is a cell member of photonic cells 2,3,4, . . . 7 that have their respective base inside cell 1. Corollary 2 is graphically illustrated in FIG. 5b.

Equipped with the information provided by photonic cells, one would know immediately whether an optical signal would require signal regeneration, without having to perform any link engineering on the fly.

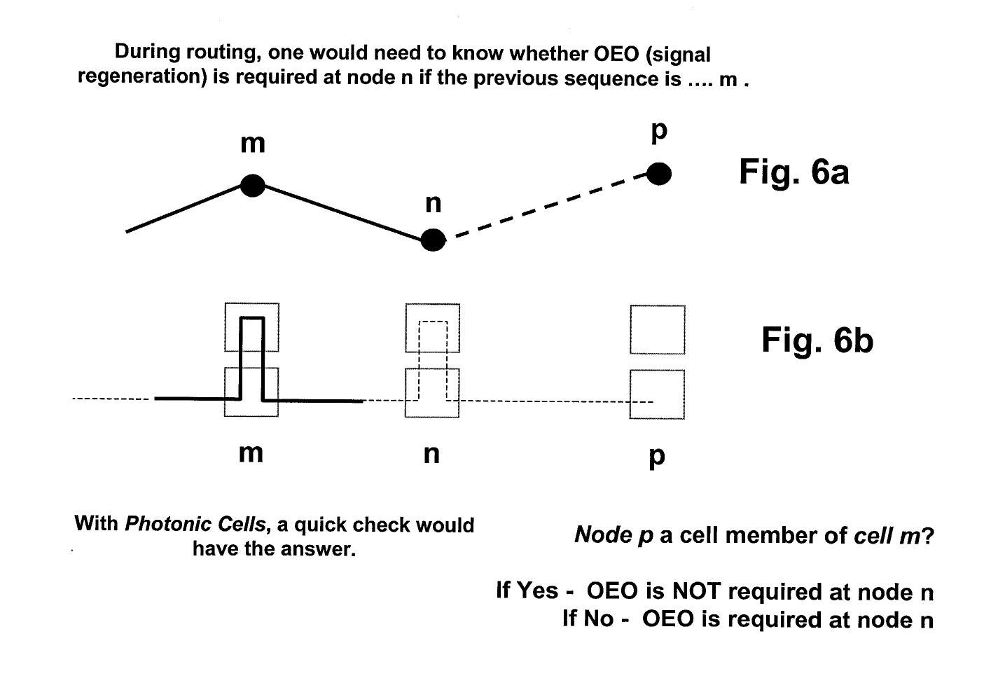

The basic application of the photonic cells in routing is depicted in FIGS. 6a and 6b. FIG. 6a, graphically illustrates a path through optical network nodes m, n and p. FIG. 6b illustrates in a block diagram a signal path through optical network nodes m, n, and p. Regardless of routing objectives and implementations, there will come a time when one needs to know whether a potential next hop (for example from node n to node p) can be reached without OEO regeneration at node n.

The answer can be obtained simply by checking whether node p is a cell member of photonic cell m. If node p is indeed a member of cell m, OEO is not needed at node n; otherwise, OEO is needed at node n as optical signals cannot reach node p photonically.

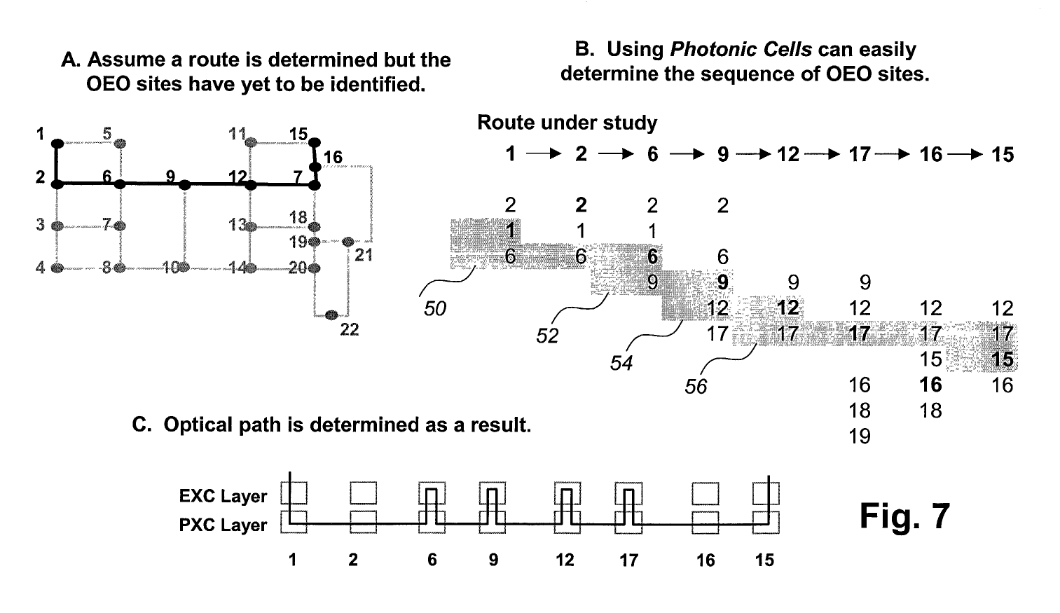

Referring to FIGS. 7a, b, and c, there is illustrated a further routing example using photonic cells. In this example, a route has been determined as shown in FIG. 7a. What is left to decide is the optical path. That is at which node the optical path needs to go through OEO for signal regeneration.

A survey of the cell members of each node on the route, one can easily devise a sequence of OEO sites as shown in FIG. 7b. A table is established with the firm now listing the nodes on the proposed route. The column under each node lists the cell members for that node. These members are given a common row orderly. Then the rows are shaded to indicate optical reach. For this example node 6 is the furthest from node 1 so shading in row 50 indicates. That a signal can reach from node 1 to node 6 photonically and that node 6 is the node at which regeneration of the optical signal must occur. Since node 9 is the only node that can be reached from node 6 (in the forward direction), node 9 is the next OEO regeneration node as indicated by the shading in row 52. From node 9 both node 12 and node 17 can be reached as indicated by shading in rows 54 and 56, respectively. Hence the further node, node 17 is used. Finally from node 17, node 15, the distribution can be reached, as indicated by the shading of row 56. FIG. 7c shows the resulting optical path in a block diagram.

There are many potential applications for photonic cells as there are a large number of potential applications of photonic cells with routing algorithms.

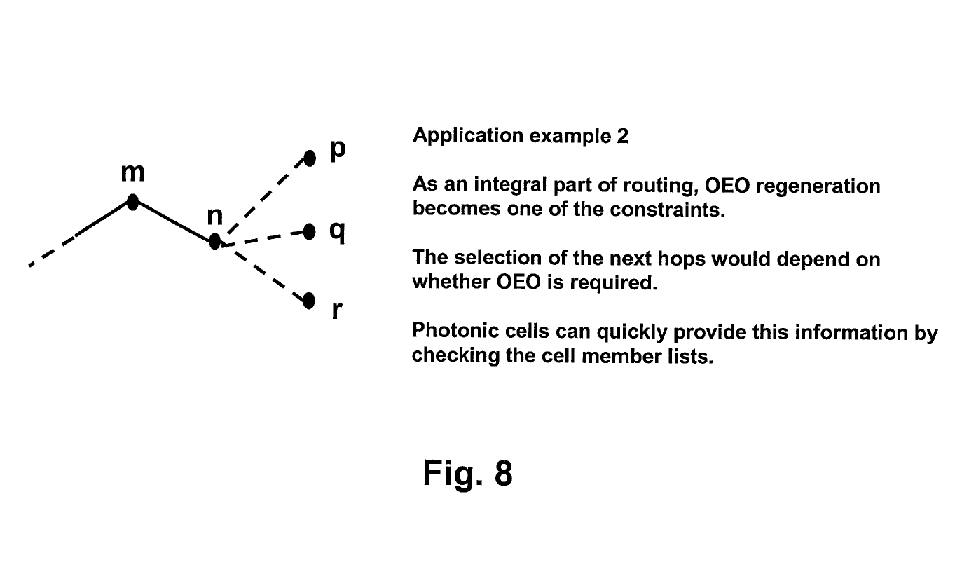

Referring to FIG. 8, there is graphically illustrated another application of photonic cells to routes. As integral part of routing, OEO regeneration becomes one of the routing constraints. Hence a routing algorithm may determine three possible next hops, for example nodes p, q, and r in FIG. 8. The selection of next hop would depend on whether OEO was required. Through photonic cells membership lists, this information can be determined quickly.

As a generic tool, the present invention does not prescribe any specific routing objectives, applications and implementation. There are at least two major implementation methods for the photonic cells.

Centralized Databases

The information of all the photonic cells can be stored in one centralized location. The information is input by a separate process and can be polled by the routing function as needed.

Distributed Routing Protocols

The information of the photonic cells is incorporated into the routing protocols. It is distributed throughout the nodes so that all the nodes would have a complete picture of the cells making up the network.

What is claimed is:

1. A photonic cell comprising:
a base node and
a plurality of member nodes, each member node within optical reach from the base node.

2. An optical network as claimed in claim 1 wherein the base node is within optical reach from at least one of the member nodes.

3. An optical network as claimed in claim 1 wherein the base node is within optical reach of the plurality of member nodes.

4. An optical network as claimed in claim 1 wherein each of the plurality of member nodes is a base node for its own photonic cell.

5. An optical network comprising;
a plurality of photonic cells, each cell including a base node and
a plurality of member nodes, each member node within optical reach from the base node.

6. An optical network as claimed in claim 5 wherein each photonic cell overlaps at least one node with at least two other photonic cells.

7. An optical network as claimed in claim 6 wherein each node in an overlap between two photonic cells includes optical regeneration.

8. An optical network as claimed in claim 7 wherein the optical regeneration includes optical-electrical-optical conversion.

9. An optical network as claimed in claim 7 wherein the optical regeneration includes wavelength conversion.
